(19) United States
(12) Patent Application Publication
(10) Pub. No.: US 2013/0124966 A1
(43) Pub. Date: May 16, 2013

(54) NETWORK SYSTEM COMPRISING A COMPUTER AND A READING DEVICE

(71) Applicant: OCE-TECHNOLOGIES B.V., Venlo (NL)

(72) Inventors: Matthieu W., J. HELDER, Beringe (NL); Bart A., C. VAN AS, Eindhoven (NL); Rene F., A. COLLARD, Gennep (NL); Anita C. MORSKATE, Tegelen (NL)

(73) Assignee: OCE-TECHNOLOGIES B.V., Venlo (NL)

(21) Appl. No.: 13/736,682

(22) Filed: Jan. 8, 2013

Related U.S. Application Data
(63) Continuation of application No. PCT/EP2011/060820, filed on Jun. 28, 2011.

(30) Foreign Application Priority Data
Jul. 8, 2010 (EP) 10168839.8

(51) Int. Cl. G06F 17/21; G06F 17/24

(52) U.S. Cl. CPC G06F 17/211; G06F 17/241
USPC 715/230; 715/249

(57) ABSTRACT

A network system includes a computer and an apparatus for reading digital documents, including an apparatus display being connectable to a communication channel of the computer via a connector. The computer includes a converter to convert a document to a format displayable by the apparatus, a first watching unit to watch the communication channel for arrival of the apparatus, and a second watching unit to watch a user's activities on the computer. The apparatus includes a detector to detect a moment in time when the user starts to work with the apparatus, and a notification device configured to send a notification to the computer via the connector. The computer is configured to establish upon receipt of the notification a transfer of the converted document from the computer via the connector to the apparatus, and the apparatus is configured to show a converted document on the apparatus display.

### CROSS-REFERENCE TO RELATED APPLICATIONS

This application is a Continuation of International Application No. PCT/EP2011/060820, filed on Jun. 28, 2011, and for which priority is claimed under 35 U.S.C. §120, and which claims priority under 35 U.S.C. §119 to Application No. 10168839.8, filed on Jul. 8, 2010. The entirety of each of the above-identified applications is expressly incorporated herein by reference.

### BACKGROUND OF THE INVENTION

1. Field of the Invention

The present invention relates to a network system comprising a computer comprising a computer display, a central processor unit, a memory unit and a communication channel, and an apparatus for displaying digital documents, comprising an apparatus display, the apparatus display being connectable to the communication channel of the computer via a connector. The present invention further relates to a method for working with such a network system.

2. Background of the Invention

An apparatus for displaying digital documents is used by a user to read documents on an apparatus display that is part of the apparatus. The apparatus display is adapted to facilitate an easy and restful reading of documents. Such an apparatus may be a so-called e-reader, an iPad®, a tablet PC or slate, or a handy, portable device with an integrated display. Documents to be read may contain text parts as well as drawings, such as books, manuals or any other type of documents. A document data format, which is suitable to be displayed on the apparatus display, may be a format like PDF, EPUB, MOBI, HTML, CHM or XPS.

In order to get a document from the computer to the apparatus, the apparatus is usually connected to the communication channel of the computer via a connector. The connector may be a connection cable or a wireless connection. If a user desires to read a document, the user selects the document, for example, in an upload application residing on the computer and starts an upload of the selected document to a memory part of the apparatus via the connection connector. The apparatus has a facility to show all the uploaded documents and to let the user select an uploaded document which he desires to read.

However, this way of working is rather cumbersome, since the user has to start the upload application, select the document he wants, start the upload itself, wait until the apparatus has uploaded the desired document and select on the apparatus the just uploaded document from a list of uploaded documents.

### SUMMARY OF THE INVENTION

It is an object of the present invention to provide a network system in which the cooperation between the computer and the apparatus is strongly improved in order to get a fast view on the apparatus of a document desired to be read.

According to an embodiment of the present invention, this object is achieved by a network system of the type indicated above, in which the computer comprises a converter to convert a document residing in the memory unit of the computer to a format displayable by the apparatus, a first watching unit to watch the communication channel for connection with the apparatus, a second watching unit to watch a user's activities on the computer, enabling an accurate update of the converted document due to the user's activities by the converter, and the apparatus comprises a detector configured to detect a user event related to the apparatus, wherein the computer is configured to establish, upon detection of the user event, a transfer of the converted document from the computer via the connector to the apparatus.

Part of the start up of the computer is the start up of the first watching unit. In this way, the computer watches the communication channel for arrival (connection) of the apparatus. When the apparatus has arrived, i.e. a connection between the computer and the apparatus has been established, the status of the converter becomes a stand-by status. This means that the converter is ready to convert a document residing in the memory unit of the computer. Such a conversion may actually happen automatically, if a document is opened on the computer and displayed on the computer display. All opened documents may be converted or the conversion may also be limited to a category of documents, for example editable documents, like Word, Excel, PowerPoint or Access documents, or only documents that are displayable on the apparatus. Documents that are already in a suitable format for display on the apparatus do not have to be converted by the converter. In that case, the converter will stay idle.

The fact that a document needs to be opened in order to be converted is advantageous for the load of the central processor unit of the computer. The document is automatically converted to a format that is suitable for display on the apparatus display.

The converted document may still reside in memory on the computer. The computer comprises a second watching unit to watch the user's activities on the computer. The user may edit or otherwise change the opened document, which may have an effect on the display of the document on the computer display. Moreover, every change to the document may have such an influence. To have an accurate and up-to-date converted document in the memory unit, the converter may update the converted document according to an update criterion. Such an update criterion may be, for example, a number of changes of the opened document or a lapsed period of time after the last update of the opened document. The update may include a renewed conversion of the edited and/or saved document.

The apparatus also comprises a detector configured to detect a user event related to the apparatus. This may be the moment in time when the user starts to work with the apparatus. For example, the moment in time may be the moment in time at which the user picks up the apparatus or otherwise displaces the apparatus. In case that the apparatus display is implemented as a touch screen, the user event may be when the user touches the apparatus display or even points at the apparatus display, for example by means of an auxiliary remote control unit. If the apparatus is powered off, the user event may also be the moment in time that the apparatus is connected to the computer and is switched on.

After the detection of such a user event, the computer starts a transfer of the converted document from the computer via the connector to the apparatus. In this way, the transfer of the document is immediately after the user event. There is no time lost for the user who wants to start working with the converted document at the apparatus.

In an embodiment of the present invention, the apparatus is configured to initiate the user event and comprises a notification device configured to notify at the user event a notification to the computer via the connector in order to start the transfer. The notification may be a message in a predetermined protocol or language understandable for the computer. The communication channel of the computer receives the notification via the connector, whereupon the computer starts a transfer of the converted document from the computer via the connector to the apparatus. In this way, the transfer of the document is immediately after the user event. There is no time lost for the user who wants to start working with the converted document at the apparatus.

In an embodiment of the present invention, the computer is configured to initiate the user event. The user event is initiated at the computer, for example via a mouse-click on a specific button or any other interactive action of the user working with the computer, such as a click on a button in a toolbar, a selection of an option in a context menu, a click of an option in a menu, a single click with a dedicated mouse or keyboard button or dragging a document to an icon placed on a desktop screen of the computer. According to this embodiment, there is no need for a device in the apparatus notifying the computer, since the user event is already initiated at the computer.

In another embodiment, the apparatus is configured to show the converted document on the apparatus display immediately after transfer. Immediately after the converted document is transferred to the memory of the apparatus, the apparatus may show the converted document on the apparatus. The user does not waste time when changing from working at the computer to reading at the apparatus.

According to an embodiment of the present invention, the computer in the network system is also configured to send metadata belonging to a document to be converted along with the converted document to the apparatus and the apparatus is also configured to show the converted document on the apparatus display taking the metadata into account. The metadata may contain additional information related to the appearance of the document on the computer display. Such metadata is taken into account when displaying the document at the apparatus display. For example, if the document contains a plurality of pages and on the computer the second page is displayed, this second page will be the page which is shown at the apparatus display after the transfer of the converted document to the apparatus.

According to an embodiment of the present invention, the metadata comprises a position in the document at which the document is shown on the computer display. For example, if the user is watching a third page of a document and the page is so large that the user has to scroll the page on the computer display to read the whole page, the third page may be partially displayed on the computer display, for example with line 40 as a first line on the display. The metadata may contain, in this case, the page number 3 and the line number 40. When the page is shown on the apparatus display, the metadata of page number 3 and line number 40 will be taken into account: the user will see the page with page number 3 with the line with line number 40 as the first line on the apparatus display. This is advantageous, since the user does not have to scroll again on the apparatus display to line number 40 of page 3, but immediately gets to the right position on the apparatus display.

According to another embodiment of the present invention, the computer in the network system comprises a controller configured to control a first mode in which the detector is enabled to detect the user event and a second mode in which the detector is disabled to detect the user event. The user may want to get to the document he is working on at the computer as fast as possible at his apparatus display according to the previous embodiments. However, at some moments, for example, when the user is simultaneously or concurrently working on two documents, he may want to have one document displayed at the computer display and the other document displayed at the apparatus display. In that case, replication of the document at the computer display or transferring a change of the document at the computer display to the apparatus may not be desired by the user. The controller may set the second mode as the active mode instead of the first mode, so as to establish that the detector is disabled and does not detect the user event. The controller may be activated by a selection menu at the computer or any other user interaction item at the computer display, at which item the user may select the first mode or the second mode.

The second mode may be implemented in such a way that the document is nevertheless transferred to the apparatus only for user events initiated at the computer.

According to another embodiment of the present invention, the computer display shows an adjustable list of documents. Each of the documents in the list may be (multi-) selected by a user of the computer in order to transfer the selected document(s) to the apparatus. This is advantageous in a case in which the offer of documents is often the same or the documents are periodically issued, for example in a kiosk, bookshop or any other structure from which newspapers or any other readable items are sold.

The present invention also discloses a method for use in a network system comprising a computer comprising a memory unit, a communication channel and a computer display, an apparatus for displaying digital documents, the apparatus comprising an apparatus display, and a connector between the computer and the apparatus, the method comprising the steps of automatically converting a digital document residing in the memory unit of the computer to a format displayable by the apparatus, automatically watching the communication channel for connection with the apparatus, automatically watching a user's activities on the computer, automatically adapting the converted document according to the user's activities, detecting by the apparatus of a user event related to the apparatus, transferring the converted document from the computer to the apparatus via the connector, and showing the converted document on the apparatus after transfer. The user is able to start reading a document, opened on his computer, on the apparatus display immediately after picking up his apparatus or displacing his apparatus otherwise.

According to another embodiment of the method, the step of detecting the user event is initiated by the computer.

According to another embodiment of the method, the step of detecting the user event is initiated by the apparatus and the method comprises the step of notifying the computer by the apparatus via the connector of the user event before the transfer step.

Another embodiment of the method according to the invention further comprises the steps of annotating the displayed document on the apparatus, automatically saving the annotated document on the apparatus, and automatically transferring the annotated document to the memory unit of the computer via the connector. Some apparatuses for reading documents are able to let the user annotate the document shown on the apparatus display with a pen or the like, for example when the apparatus display is a touch screen. It is advantageous to save these annotations immediately on the computer. In this way, the user may be able to communicate the annotated document via a network to other interested users.

Another embodiment of the method further comprises the step of automatically showing the annotated document on the computer. By doing so, the user can immediately edit the document on his computer and finish the document by saving the edited document on his computer.

Another embodiment of the method is characterized in that the user event is determined as the moment in time when the apparatus is displaced. As long as the apparatus is not displaced, it is assumed that nobody is using the apparatus. The inventors have recognized that a displacement of the apparatus, for example a pick up of the apparatus by the user or another kind of move of the apparatus, may be interpreted as an indication that the apparatus is going to be used for reading or otherwise worked with.

According to another embodiment of the method, the user event is determined by a moment in time when the display of the apparatus is touched or pointed at. The display of the apparatus may be a touch screen. It is easy for the user to touch the apparatus display in order to notify the computer that he wants to read a document on the apparatus, which document is at the moment shown at the computer display.

Another embodiment of the method further comprises the step of sending metadata belonging to a document to be converted along with the converted document to the apparatus and the step of showing the converted document on the apparatus display taking the metadata into account. Such metadata may be an actual page number and/or actual line number, which are displayed on the computer display. In this way, the apparatus will show the user the document at the page number and the line number, which numbers correspond to the page number and the line numbers on the page that are shown at the computer display. By putting the page number and the line number in the metadata, the apparatus is able to show the document on the apparatus display at the position which is determined by the page number and the line number. Instead of or besides a page number and a line number, the metadata may contain any other data suitable for determining a position of the document on the computer display and a desired position on the apparatus display.

In another embodiment of the network system according to the present invention, the network system comprises a second computer being connectable to the computer via a second connector, wherein the second computer comprises a converter to convert a document residing in the memory unit of the computer to a format displayable by the apparatus, wherein the computer is configured to establish upon receipt of such a notification a transfer of the converted document from the second computer via the second connector to the apparatus. This is advantageous, since the first computer does have the burden of converting documents, since this is placed out on the dedicated second computer being reachable via the network by means of the second connector.

In an advantageous embodiment, the computer may not comprise any converter, since converting is done at the second computer. In another advantageous embodiment the converted document may be sent directly from the second computer to the apparatus, provided that a connection is established in the network system between the second computer and the apparatus.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view of a network system according to the present invention;

FIG. 2 is a first flow diagram of a method according to the present invention; and

FIG. 3 is a second flow diagram of an additional method according to the present invention.

### DETAILED DESCRIPTION OF THE PREFERRED EMBODIMENTS

The present invention will now be described with reference to the accompanying drawings, wherein the same or similar elements are identified with the same reference numeral.

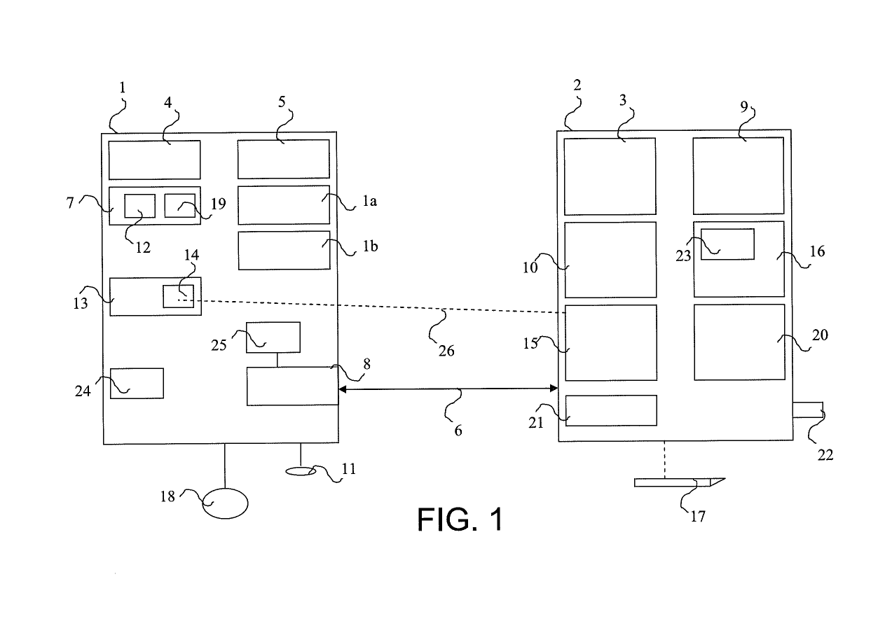

FIG. 1 shows a schematic view of a network system according to the present invention comprising a computer 1, which is connected to an apparatus 2 for displaying documents. The computer 1 comprises a central processor unit (CPU) 4, a hard disk 5, a memory 7, a computer display 1a, a key board 1b, a communication channel 8, a first watching means or unit 25, a second watching means or unit 15, a converter means or converter 12 and switching means or switch 24. The communication channel 8 may be connected to the apparatus 2 via a connection 6. Such a connection 6 may be accomplished by means of but not limited to a connection via USB, Ethernet, WiFi, infrared or Bluetooth technology. The computer 1 may also be integrated in a network 18 for intranet and/or internet or any other digital network. The first watching means 25 watches the communication channel 8 for connection with the apparatus, which determines a stand-by status of the converter means 12. The first watching means 25 may be implemented as a logical drive watcher like a win 32 logical drive watcher.

When a user works on a document on the computer 1, the memory 7 of the computer 1 may contain a document 19 he is working on. The user may work in an application like MS outlook file plug-ins, MS Windows Explorer file plug-ins, MS Internet Explorer file plug-ins or any word-processing application, spreadsheet application or user presentation application. In case of a touch screen as a computer display, the keyboard 1b may be integrated and displayed as part of the computer display 1a.

The apparatus 2 comprises an apparatus display 3, a detecting means or detector 9, a notifying means or device 10 and an apparatus memory 16. The apparatus display 3 may be a touch screen. The detecting means 9 are able to detect a displacement of the apparatus 2, for example an accelerometer such as a tilt sensor or G-sensor. The accelerometer measures proper acceleration of the apparatus experienced relative to freefall.

Single- and multi-axis accelerometers are available to detect magnitude and direction of the acceleration as a vector quantity, and can be used to sense orientation, acceleration, vibration shock, and falling of the apparatus. The accelerometer may be a micromachined (MEMS-) accelerometer in order to detect the position of the apparatus.

Another kind of detecting means 9 may be a proximity sensor which is able to detect the presence of nearby objects without any physical contact. Such an object may be a user's hand or any object pointing towards the apparatus. The proximity sensor may emit an electromagnetic or electrostatic field, or a beam of electromagnetic radiation and looks for changes in the field or a return signal. The sensor may be capacitive, photoelectric or inductive.

Otherwise, the detecting means 9 may be able to detect a change in readings of an ambient light sensor in the apparatus 2, a pre-specified gesture of a mouse 11 connected to the computer 2, a push on a button 21 on the apparatus 2, a disconnection of a charging plug 22 of the apparatus 2, an activation of the apparatus display 3, e.g. a touch of the apparatus display 3 in the case of a touch screen, recognition of voice commands through a microphone 20, which may be part of the apparatus 2, closing a lid (not shown) of the connected computer 1 or powering off the computer display 1a.

The switching means or switch 24 of the computer 1 may be used to switch from a first mode to a second mode. The first mode may be implemented as a mode in which the apparatus 2 is continuously or periodically synchronizing with the computer 1. The second mode may be implemented as a mode in which the apparatus 2 is not synchronized with the computer 1. Nevertheless, a user at the computer may be able by means of dedicated buttons on the computer display 1a, by means of a special button on the mouse 11 or by means of a special button on the keyboard 1b, to initiate a conversion, if needed, and a transfer of a document to be read at the apparatus 2 to the apparatus 2. In an embodiment which only implements the second mode, the apparatus 2 may even be constructed without the detecting means 9 and the notifying means 10.

The first mode will be elucidated hereinafter. The apparatus 2 may continuously synchronize with the computer display 1a, displaying the document that is concurrently displayed on the computer 2 in a format that is capable for the apparatus 2, or the file that is selected either in a file management application 13 on the computer 1 such as Windows Explorer or similar applications or a file that is attached to, e.g. an e-mail message in a mail client such as Microsoft Outlook, Lotus Notes, Google Mail and so on.

Alternatively, the apparatus 2 may synchronize only after a certain document has been displayed or selected on the computer 1 for longer than a predetermined period of time, e.g. 10 seconds.

When the detecting means 9 of the apparatus 2 is triggered, the notifying means 10 notifies the computer 1 via the connection 6 that a document residing on the computer 1 is desired for display on the apparatus display 3. The notifying means 10 may be an application for sending messages via the connection 6 to the computer 1, e.g. the notifying means is watching perceptions of an accelerometer and/or a proximity sensor. Values of the perceptions may exceed a threshold value indicating a predetermined kind of movement of the apparatus. When the threshold is exceeded, a notification is sent to the computer 1.

When the computer 1 is notified, the converter means 12 residing as a software application in the memory 7 of the computer 1 are started up by the CPU 4 in order to select a suitable document format for display on the apparatus 2. Such a selection may depend on a source format of the document. Such a suitable document format may be PDF, EPUB, MOBI, HTML, CHM, XPS, or any other suitable document format. After the selection of the suitable document format, the document is converted by the converter means 12 in the suitable document format. Such a converter means is nowadays available for many file formats. Information in the original document may steer the conversion. For example, an A0 size PDF containing a CAD drawing using many vector elements may be optimized to an A5-size PDF containing rasterized drawings. This allows for much faster viewing on the apparatus 2. If the source format of the document is already suitable for display at the apparatus, conversion may be superfluous. The converter means may also be able to optimize the converted document for display at the apparatus. Such an optimization may also be executed by an optimization means or unit (not shown), which is engaged after the conversion step made by the converter means.

Metadata belonging to the document are created, which comprise data related to the document relevant for a correct and accurate display of the document on the apparatus 2. The metadata may contain position information regarding a current page and page-lines, a zoom level, a lay-out option like available in document applications, like a reading lay-out, a print lay-out, a web view, or a 2-pages-on-1-display view and the like, or a mode for displaying tracked changes.

For example, the current page that is displayed on the computer display 1a at the time of the notification, and the lines of the current page of the document, which are displayed on the computer display 1a at the time of the notification can be displayed on the apparatus 2 with the same page and lines as the display 1a.

Metadata may be transferred to the apparatus via a hot folder mechanism or via inter-process communication also known as IPC. If the metadata is transferred via a hot folder, the metadata may be written to a file that is linked to the converted document, e.g. a job ticket. The transfer of metadata via a hot folder may be implemented with a standard PPD (Postscript Printer Description) driver.

The converted document and the corresponding metadata may be placed in a folder 14 in the file management system 13 of the computer 1, which folder 14 is dedicated to contain documents which have to be ready to get transferred to the apparatus 2, for example via a hot folder mechanism installed at and programmed on the computer 1. From such a folder 14, the converted document and the corresponding metadata are transferred via the connection 6 to the apparatus 2. This transfer may be initiated by the computer 1 or by the apparatus 2.

In the latter case, the apparatus 2 may be equipped with the second watching means 15 instead of the computer 1. The second watching means monitors the dedicated folder 14 on the computer 1. In FIG. 1, the monitoring process is indicated by a dashed arrow 26. Exchange of commands, information, metadata and/or files due to the monitoring process is accomplished via the connection 6. Periodically, the second watching means 15 may check changes in the hot folder 14, which principal is also known as “polling.” The second watching means 15 implements a pull of information, but an implementation according to a “push” principal is not excluded. For example, by a notification from the computer 1, the apparatus 2 receives a message in which the apparatus is notified that in the watched folder 14 a change has occurred.

If more than one reading apparatus is connected to the computer 1, separate hot folders may be used to distinguish the separate reading apparatuses.

If the computer 1 initiates the transfer, the second watching means 15 is residing on the computer 1. The second watching means 15 may be a software or hardware implementation residing in the memory 7 of the computer 1.

The transferred document is loaded in the apparatus memory 16 of the apparatus 2 and displayed on the apparatus display 3 with the current page, as read from the metadata, at the correct position on the current page, also as read from the metadata, to allow the user to continue reading the document on the apparatus 2.

The apparatus 2 may continuously synchronize with the computer display 1a. When the user edits or otherwise changes the document on the computer 1, the document may be converted again and a new converted document together with new metadata, if appropriate, may be transferred to the apparatus 2 for immediate display on the apparatus display 3. If the document itself is not changed, but the position in the document shown on the computer display 1a changes, only metadata may have to be adapted and transferred to the apparatus 2. On the other hand, if the user scrolls through the document on the apparatus 2, metadata may also be sent from the apparatus 2 to the computer 1 in order to update the computer display 1a with the actual position in the document displayed on the apparatus display 3. In this way, a bi-directional synchronization is achieved.

The document displayed on the apparatus 2 may also be annotated. For example an e-reader may be accompanied by a pen 17 for drawing on the apparatus display 3 to make annotations. Such a pen 17 is registered by the apparatus. The pen type is dependent on the type of display of the apparatus. For capacitive displays, a conductive pen (stylus) may be necessary. Resistive displays have no direct requirement, except the requirement that the pen exerts pressure upon the display. The display may have an electro-magnetic detection layer, which reacts to an electromagnetic pen. The annotations may be saved and transferred back to the computer 1, in order to get the recently annotated document available on the computer 1.

In another embodiment, every document that is active on the computer 1, for example the document displayed on the computer display 1a, may be converted and transferred along with corresponding metadata to a predetermined folder 23 of the apparatus memory 16 of the apparatus 2. This may be organized in such a way that only the active document resides in the predetermined folder 23, for example by deleting previous active documents from the folder 23 as soon as a new active document is transferred. In the case of an original MS Word document with document attributes, a plurality of folders may be created in the apparatus memory 16 of the apparatus 2 and the kind of document attributes may determine in which folder in the apparatus memory 16 of the apparatus 2 the converted document is placed.

In the case of disconnecting the apparatus 2 from the computer 1, the apparatus 2 may immediately load the document from the predetermined folder 23 to the apparatus display 3 in order to display the page that was recently displayed on the computer 1 according to the metadata of the document.

In another embodiment, the computer 1 is a host PC and the apparatus 2 is an e-reader. The e-reader is connected to the host PC via a WiFi network: both the host PC and the e-reader are connected via the same WiFi network (same SSID). A user on the host PC opens a Word document attached to an e-mail. At the moment Word is opened, this document is converted to PDF in a background process on the host PC. This PDF document is set ready in a temporary folder on the host PC. While the user is scrolling the document in Word, a metadata XML file is constantly updated and placed in the temporary folder. This metadata file contains the page number the user is viewing in Word. If the user makes edits in the Word file, a new PDF file is immediately generated, which replaces the old PDF file in the temporary folder. The user picks up the e-reader, which is recorded by an accelerometer or a proximity sensor comprised in the e-reader. At that moment, the PDF file and the metadata XML file are transferred to the e-reader, loaded on the e-reader display and the PDF file is shown at the e-reader display at a page corresponding to the page recorded in the XML file, i.e. the page the user was viewing in the Word document.

In another embodiment, the computer 1 is a host PC and the apparatus 2 is a tablet PC. The tablet PC is connected to the host PC via a USB cable connection. The user opens a PDF document located on the hard drive. At the same moment, the PDF file is transferred to the tablet PC and shown full-screen on its display. While the user is navigating through the PDF file on the host PC, the tablet PC is immediately “following” the navigation through the document. When the user makes edits to the file (e.g. text edits or annotations), immediately the PDF file is saved in the background, transferred to the tablet PC and shown full-screen on its display, on the correct page.

In another embodiment, the computer 1 is a host PC and the apparatus 2 is an e-reader connected to the host PC via a USB cable connection. The user opens an e-mail message in the messaging client. The e-mail message, including possible attachments, is immediately converted to a PDF format in a background process. The PDF document or documents are set ready in a temporary folder on the host PC, and an XML file is generated. While the user is navigating through the e-mail message or its attachments, the XML file is constantly updated with the page number of the corresponding PDF file. Continuously, the PDF documents and the XML file are transferred (synchronized) with a specified folder on the e-reader. The user disconnects the e-reader from the host PC by unplugging the USB cable. This event triggers the e-reader to load the PDF document corresponding to the message or attachment the user was viewing recently, and showing it on the correct page number.

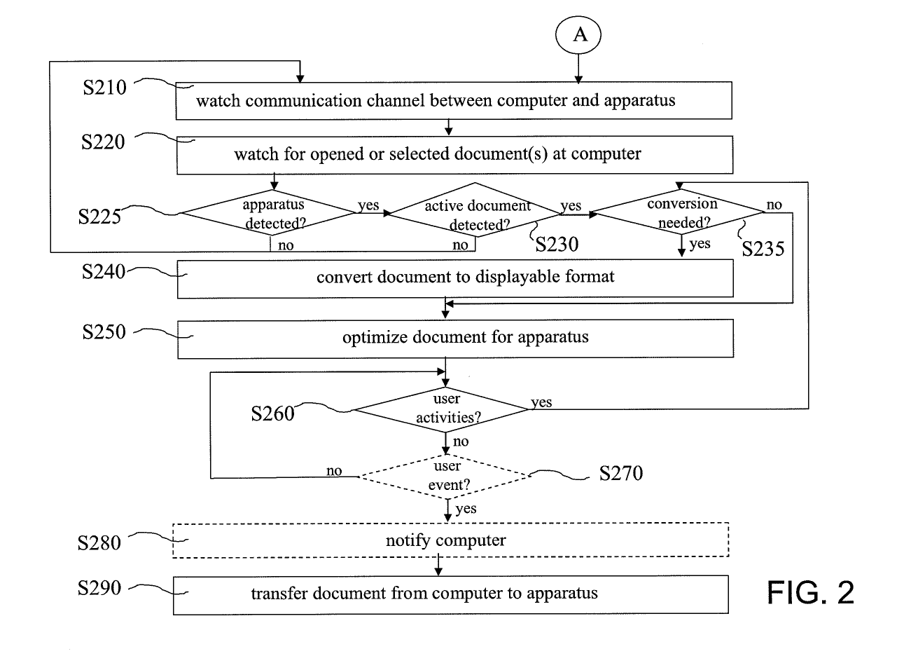

FIG. 2 is a first flow diagram of the method according to the invention. In the diagram, a starting point A, steps S210, S220, S240, S250, S280, S290 and decision steps S225, S230, S235, S260, and S270 are distinguishable. The steps S210, S220, S240, S250 and S290 and the decision steps S225, S230, S235 and S260 are carried out by the computer, while a fifth decision step S270 (dashed diamond) and a fifth step S280 (dashed rectangle) are carried out by the apparatus.

The diagram is to be read from starting point A, after which a first step 210 is executed. In the first step S210, the first watching means of the computer watches the communication channel of the computer. In a second step S220 the second watching means of the computer watches for a document to be selected by the user or to be opened by the user. Hereinafter, such an opened and/or selected document is called an active document. In a first decision step S225, it is checked by means of the first watching means whether an apparatus is connected. If an apparatus is connected, a second decision step S230 is carried out in order to check by means of the second watching means if there is an active document on the computer. If an active document is detected, a third decision step S235 is carried out in order to check whether or not a conversion of the active document is needed. This third step 235 may be carried out by the conversion means. If checks of the first decision step S225 or the second decision step S230 are negative, no further actions are required and the first and second watching means keep watching.

If the apparatus is detected, and an active document is detected, and a conversion of the active document is needed, in a third step S240, the active document is converted into a format that is displayable at the apparatus display. The need for a conversion may depend on the specifics of the apparatus, such as the native formats that the apparatus supports as well as the specifics of the e-reader itself, like screen size and resolution and processing power of the apparatus. The specifics of the format of the active document, which specifics also include extension-based and signature-based recognition of the format of the active document, are compared to the specifics of the apparatus to decide whether or not to convert the document. If no conversion is needed, for example, if the active document is already in a displayable format, the third step S240 is skipped and the method proceeds with a fourth step S250.

After conversion of the active document, also the fourth step S250 is carried out in order to optimize the converted document for the apparatus. A reason for the optimization step may be limitations of the apparatus. For example, the resolution of the documents and/or images on the apparatus display may be adapted due to performance reasons. In the case of a PowerPoint presentation, which contains animations or display layers, the presentation may be converted to separate pages. The optimization step may be necessary for the benefit of the user of the document or information data, for example a conversion of the document or information data into columns which enhances the legibility. On the other hand, if no conversion is needed according to the check at the third decision step S235, it may be that optimization of the document is not needed and that the fourth step S250 may be skipped.

After the fourth step S250, a fourth decision step S260 is carried out to check if there are any user activities on the active document on the computer. If so, the method returns to the third decision step S235 to check whether a new conversion is needed. The check on the user activities may be periodically, for example every minute or 20 seconds, which period may be adjustable by means of settings in the computer.

If there are no more user activities, a fifth decision step S270 is carried out in order to check if a user event has happened. User events that are to be checked are user events that are initiated by the user via the apparatus or via the computer. A user event via the apparatus is, for example a movement of the apparatus by the user or otherwise. A user event via the computer is a pushing of a button displayed on the computer display, which is dedicated for a command to start using the apparatus on which the active document is desired to be read by the user. If such a user event has not happened, the method returns to the point in the diagram just before the fourth decision step S260. The fourth decision step S260 and the fifth decision step S270 may be carried out periodically with an adjustable time period between the checks carried out by each of the steps S260, S270.

If a user event is detected, which is initiated by means of the apparatus, notifying means of the apparatus notify the computer in a fifth step S280 that a user event has happened. If a user event is detected, which is initiated by means of the computer, the fifth step 5280 is skipped and the method proceeds with a sixth step S290 according to the diagram. After the computer is notified, the sixth step S290 is also carried out in order to transfer the active document from the computer to the apparatus.

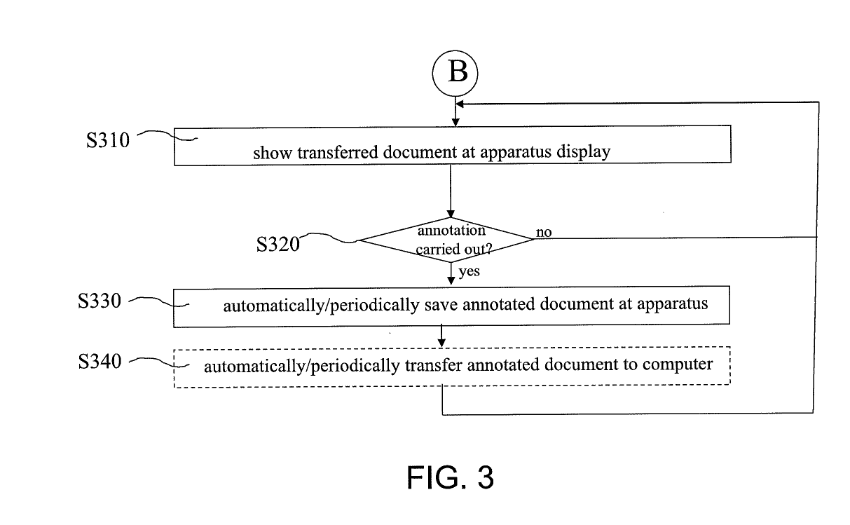

FIG. 3 is a second flow diagram of the method according to the invention, which may be applied after the sixth step S290 of the method according to the first flow diagram in FIG. 2. According to the method, a starting point B, steps S310, S330, S340 and a decision step S320 may be defined. The first step S310, the second step S320 and the decision step S320 are carried out by the apparatus, while the third step S330 is carried out by the computer (dashed rectangle).

After the document is transferred to the apparatus, in a first step S310, the transferred document may be immediately shown at the apparatus display. The user starts reading the document at the apparatus display. The user might feel like annotating the document. In an embodiment of the apparatus, the apparatus comprises a pen by means of which the displayed document may be annotated. A decision step S320 checks whether the document is annotated at the apparatus display. If not, the method returns to the first step S310. The check in step S320 may be carried out within a predetermined time interval. If so, automatically in combination with an adjustable time period, the apparatus saves the annotated document or the annotations in combination with the document in a memory of the apparatus in a second step S330. In a last step S340, the annotated saved document may be transferred from the apparatus back to the computer after every save. In another embodiment, the last step S340 is only carried out if the user decides to stop working with the document at the apparatus.

In another embodiment, the conversion of documents does not happen on the computer, but is placed out on a second computer, which is dedicated for converting documents, for example a server. A network may connect both computers, for example in a cloud network, such as DropBox, Box.net, Google Docs and the like. Such a second computer may receive from the computer, on which the user is working, via the network a document which has to be converted. After conversion on the second computer, the converted document may be sent back to the computer the user is working on and from latter computer to the apparatus. This is advantageous since the second computer may be dedicated for converting and/or storing documents, while the burden of the central processor unit of the computer of the user is substantially lowered.

In order to decrease network traffic, in another embodiment, the network also connects the second computer and the apparatus, and the converted document may be sent directly from the second computer to the apparatus. In this embodiment, the notification means of the apparatus may not send a notification directly to the computer of the user but directly to the second computer in order to get the converted document from the second computer via the network to the apparatus.

In another embodiment, the apparatus is provided with a loud speaker for reproduce human language. If the apparatus is moved or additional loud speakers are plugged in at the apparatus, the document on the computer is transferred according to the previous embodiments to the apparatus. Instead of or besides displaying the document on the apparatus display, the document may be reproduced by means of a spoken language via the loud speakers. This may be advantageous when visually disabled persons are using the apparatus or when reading out stories to children. In this embodiment, the apparatus display may be turned off as soon as the story is being told in order to save energy.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A network system comprising:
a computer comprising a computer display, a central processor unit, a memory unit and a communication channel; and
an apparatus for displaying digital documents, comprising an apparatus display, the apparatus display being connectable to the communication channel of the computer via a connector,
wherein the computer comprises:
a converter configured to convert a document residing in the memory unit of the computer to a format displayable by the apparatus;
a first watching unit configured to watch the communication channel for connection with the apparatus, the first watching unit determining a stand-by status of the converter; and
a second watching unit configured to watch a user's activities on the computer, enabling an accurate update of the converted document due to the user's activities by the converter,
wherein the apparatus comprises a detector configured to detect a user event related to the apparatus, and
wherein the computer is configured to establish, upon detection of the user event, a transfer of the converted document from the computer via the connector to the apparatus, wherein the detector comprises one of an accelerometer, a proximity sensor, an ambient light sensor, a detector configured to detect a disconnection of a charging plug of the apparatus and a microphone for voice recognition.

2. The network system according to claim 1, wherein the apparatus is configured to initiate the user event and comprises a notification device configured to send, at the user event, a notification to the computer via the connector in order to start the transfer.

3. The network system according to claim 1, wherein the computer is configured to initiate the user event.

4. The network system according to claim 1, wherein the apparatus is configured to show the converted document on the apparatus display immediately after transfer.

5. The network system according to claim 1, wherein the computer is configured to send metadata belonging to a document to be converted along with the converted document to the apparatus and the apparatus is configured to display the converted document on the apparatus display taking the metadata into account.

6. The network system according to claim 5, wherein the metadata comprises a position in the document at which the document is displayed on the computer display.

7. The network system according to claim 1, wherein the computer comprises a controller configured to control a first mode in which the detector is enabled to detect the user event and a second mode in which the detector is disabled to detect the user event.

8. The network system according to claim 1, further comprising a second computer being connectable to the first computer via a second connector, wherein the second computer comprises a second converter configure to convert a document residing in the memory unit of the first computer to a format displayable by the apparatus, wherein the first computer is configured to establish, upon receipt of the notification, the transfer of the converted document from the second computer via the second and the first connectors to the apparatus.

9. A method for use in a network system, the network system comprising a computer comprising a memory unit, a communication channel and a computer display, and an apparatus for displaying digital documents, comprising an apparatus display, and a connector between the computer and the apparatus, the method comprising the steps of:
automatically converting a digital document residing in the memory unit of the computer to a format displayable by the apparatus;
automatically watching the communication channel for connection with the apparatus;
automatically watching a user's activities on the computer;
automatically adapting the converted document according to the user's activities;
detecting a user event related to the apparatus; and
transferring the converted document from the computer to the apparatus via the connector,
wherein the detection of the user event is based on one of a displacement of the apparatus, a presence of a nearby object without any physical contact, a touch of the apparatus display, a disconnection of a charging plug of the apparatus, a recognition of a voice command and a closing of a lid of the computer.

10. The method according to claim 9, wherein the step of detecting the user event is initiated by the computer.

11. The method according to claim 9, wherein the step of detecting the user event is initiated by the apparatus and the method comprises a step of notifying the computer by the apparatus via the connector of the user event before the transfer step.

12. The method according to claim 9, wherein the method comprises the step of displaying after transfer the converted document on the apparatus.

13. The method according to claim 12, wherein the method further comprises the steps of:
annotating the displayed document on the apparatus;
automatically saving the annotated document on the apparatus; and
automatically transferring the annotated document to the memory unit of the computer via the connector.

14. The method according to claim 13, wherein the method further comprises the step of automatically showing the annotated document on the computer.

15. The method according to claim 9, wherein the user event is a displacement of the apparatus.

16. The method according to claim 9, wherein the user event is touching or pointing at the display of the apparatus.

17. The method according to claim 9, wherein the method further comprises the step of sending metadata belonging to a document to be converted along with the converted document to the apparatus and the step of displaying the converted document at the apparatus display taking the metadata into account.

18. The method according to claim 17, wherein the metadata comprises the position in the document at which the document is displayed at the computer display.
